(19) United States
(12) Patent Application Publication
(10) Pub. No.: US 2012/0068033 A1
(43) Pub. Date: Mar. 22, 2012

(54) SYSTEMS AND METHODS FOR PROVIDING MODULAR PERSONAL ACCESSORIES

(76) Inventor: Melanie Uffens, Centerville, UT (US)

(21) Appl. No.: 13/235,256

(22) Filed: Sep. 16, 2011

Related U.S. Application Data
(60) Provisional application No. 61/383,685, filed on Sep. 16, 2010.

(51) Int. Cl. F16M 13/00

(52) U.S. Cl. 248/309.1

(57) ABSTRACT

Systems and methods for providing personal accessories that are selectively and interchangeably used. A personal accessory system is provided having a base member for receiving an accessory item, the accessory item being coupled to the base member via a fastener.

### RELATED APPLICATIONS

This application claims priority to U.S. Provisional Patent Application Ser. No. 61/383,685 (Attorney Docket Number: 18312.5) titled “SYSTEMS AND METHODS FOR PROVIDING MODULAR PERSONAL ACCESSORIES' filed Sep. 16, 2010, which is expressly incorporated herein by reference in its entirety.

### BACKGROUND OF THE INVENTION

1. Field of the Invention

The present invention relates to a modular personal accessory system. In particular, the present invention relates to system and methods for providing personal accessory items that are interchangeably used with a base having a compatible mounting surface.

2. Background and Related Art

The manufacture and sale of jewelry constitutes a very large market which cuts across virtually every known consumer and wholesale channel of trade, including: department stores, jewelry specialty shops, wholesale stores, virtual or online stores, multi-level marketing programs, and mail order catalogues. Much of such jewelry is embodied in a fixed configuration which is not intended to be altered by a user.

Conventionally, jewelry is made with a specific purpose, use, or application in mind. For example, a pinned brooch is typically designed with the intention of being pinned to a piece of clothing, such as a blouse or jacket. Similarly, a watch typically includes a strap or band whereby to accommodate wearing of the watch around a user's wrist. Thus, the features of the jewelry are designed with a specific use in mind.

Jewelry is commonly used as an accessory to compliment the outfit of a user. It is not uncommon for a user to select a piece of jewelry based on the color, style or theme of the user's outfit. Additionally, a user may select a piece of jewelry based on an occasion, such as a holiday, a business meeting, a funeral, or a party. Thus, the user is required to maintain a large selection of jewelry pieces so as to be enabled the user to properly accessorize for a given outfit or occasion. Such a collection can be quite expensive and require excessive storage space.

Thus, while it is possible for a user to maintain a sufficient collection of jewelry and other accessories, challenges still exist. Accordingly, it would be an improvement in the art to augment or even replace current techniques with other techniques.

### SUMMARY OF THE INVENTION

The present invention relates to a modular personal accessory system. In particular, the present invention relates to systems and methods for providing personal accessory items that are interchangeably used with a base having a compatible mounting surface.

In some implementations, a base or strap member is provided having a surface on which to receive an accessory item, such as a watch, a brooch, a belt buckle, a piece of jewelry, and the like. A fastener is provided whereby to couple to the accessory item to the base member. Thus, in some implementations a user may interchange a first accessory item with a second accessory item on the base member.

In some implementations, an adapter is further provided to facilitate coupling of an accessory item to the base member. The adapter provides a loop having a fastener located at a terminal end, wherein the accessory item is coupled to the loop and the fastener is coupled to the base member. In some implementations the adapter is reversibly coupled to the accessory item such that a single adapter may be used with multiple accessory items.

Further, in some implementations a base member is provided having terminal fasteners whereby to directly couple an accessory item. Terminal fasteners are provided to interact with and couple with a physical feature of the accessory item. In some implementations, terminal fasteners are combined with a physical feature of a mounting plate onto which the accessory item is fixed. In other implementations, the accessory item is removably coupled to the mounting plate such that a user may interchange a first accessory item with a second accessory item.

These and other features and advantages of the present invention will be set forth or will become more fully apparent in the description that follows. The features and advantages may be realized and obtained by means of the instruments and combinations provided herein. Furthermore, the features and advantages of the invention may be learned by the practice of the invention or will be obvious from the description, as set forth hereinafter.

### BRIEF DESCRIPTION OF THE DRAWINGS

In order to set forth the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A is an exploded, perspective view of a modular personal accessory system in accordance with a representative embodiment of the present invention;

FIGS. 1B-1E illustrate representative bases for interchangeably receiving accessory items in accordance with embodiments of the present invention;

FIG. 2 is a perspective view of an adapter and an accessory item in accordance with a representative embodiment of the present invention;

FIGS. 3A and 3B are perspective back views of an adapter and an accessory item in accordance with a representative embodiment of the present invention;

FIGS. 4A and 4B are side plan views of a modular personal accessory system in accordance with a representative embodiment of the present invention;

FIG. 4C is a perspective view of a clasp system in accordance with a representative embodiment of the present invention;

FIG. 5 is a perspective view of a modular personal accessory system in accordance with a representative embodiment of the present invention;

FIG. 6 is a perspective back view of a modular personal accessory system in accordance with a representative embodiment of the present invention;

FIG. 7 is a perspective back view of a modular personal accessory system in accordance with a representative embodiment of the present invention;

FIG. 8A is a partial cross-section perspective back view of modular personal accessory system in accordance with a representative embodiment of the present invention;

FIG. 8B is an exploded cross-section view of a mounting plate and accessory sleeve in accordance with a representative embodiment of the present invention; and

FIG. 8C is a cross-section view of a mounting plate inserted within an accessory sleeve in accordance with a representative embodiment of the present invention.

### DETAILED DESCRIPTION OF THE INVENTION

The present invention relates to a modular personal accessory system. In particular, the present invention relates to a system personal accessory items that are interchangeably used with a base having a compatible mounting surface.

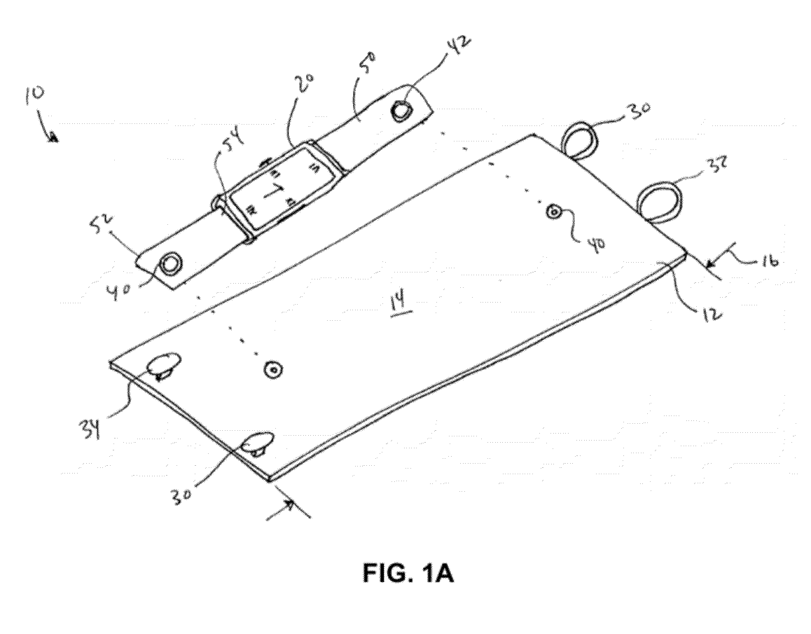

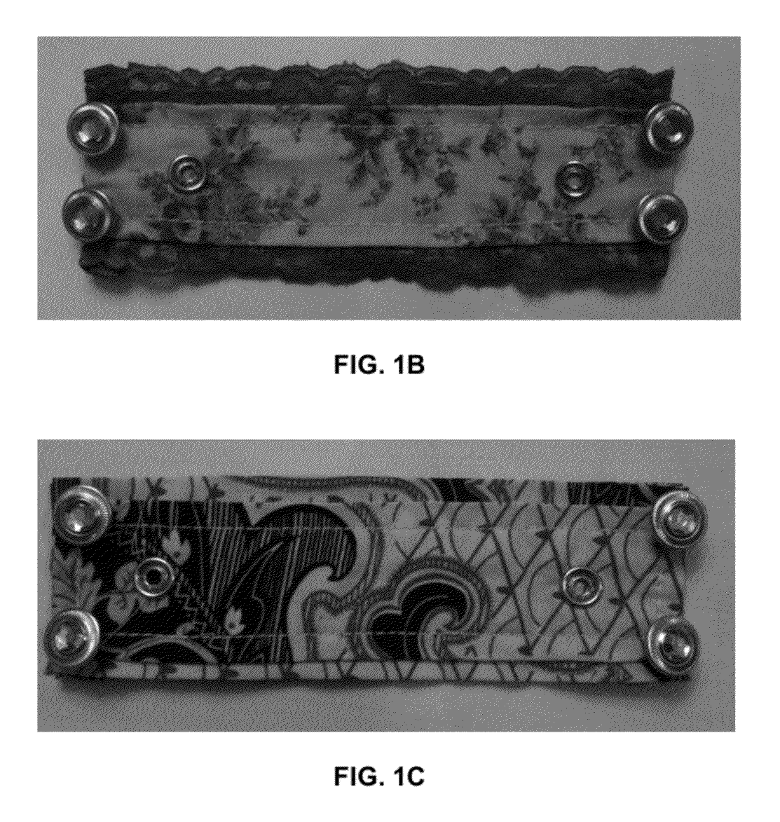

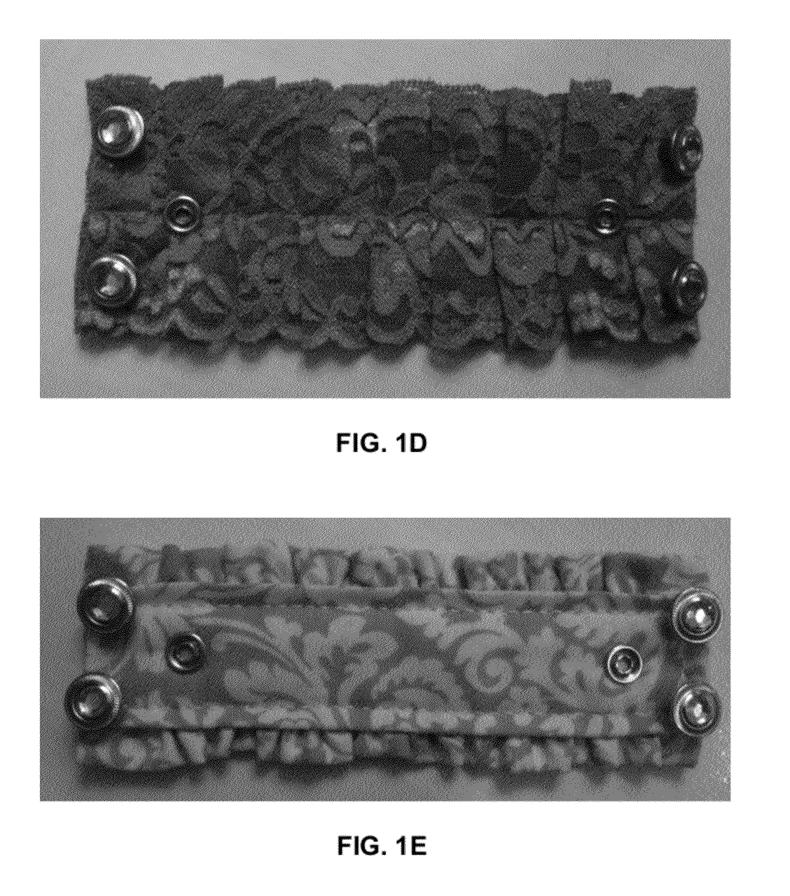

Referring now to FIG. 1A, a modular accessory system 10 is shown. In some embodiments, accessory system 10 comprises a base 12 having a surface 14 for interchangeably receiving an accessory item 20. In some embodiments, base 12 comprises a strap or band having a length 16 configured to surround the wrist of a user. In other embodiments, base 12 comprises a band or strap having a length 16 configured to surround a body part of a user, such as an ankle, a waist, an arm, a leg, a neck, or a head of the user. In some embodiments, base 12 comprises a stretchable material, such as an elastic webbing material. In other embodiments, base 12 comprises a rigid or inflexible material, such as leather, broad cloth, nylon webbing, metal, and the like.

Base 12 is generally coupled to a portion of a user's body by means of a fastener 30. In some embodiments, fastener 30 comprises a button-and-loop fastener. In other embodiments, fastener 30 comprises at least one of a hook-and-loop fastener, such as Velcro®, a snap button fastener, a latchet fastener, a clasp fastener, such as a Bocklebee clasp, a clip fastener, a buckle fastener, a zipper, a lace fastener, a magnetic fastener, any other type of suitable fastener, and combinations thereof.

In some embodiments, an inflexible base 12 material is combined with an elastic or partially elastic fastener 30. Use of an elastic fastener 30 permits a single base 12 to accommodate several body parts having various circumferences. Additionally, use of an elastic fastener 30 provides an accessory system 10 that can adapt to various circumferences of a desired body part.

For example, in some embodiments a base 12 is provided having a length 16 generally intended to fit on the wrist of a user. Base 12 further comprises an elastic loop 32 configured to compatibly receive button 34. By using elastic loop 32, an overall length of system 10 is capable of being expanded to the degree and length to which loop 32 is capable of being stretched. Thus, a single base 12 may be provided to accommodate various wrist diameters of potential users.

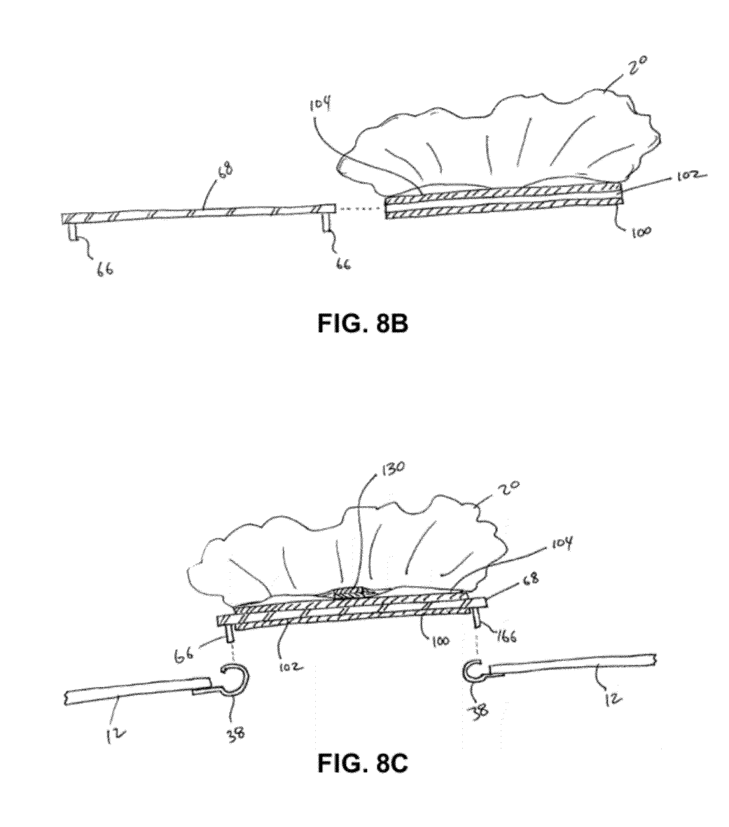

FIGS. 1B-1E illustrate representative bases for interchangeably receiving accessory items in accordance with embodiments of the present invention. In each of the representative embodiments illustrated in FIGS. 1B-1E, a base is provided having a surface for selectively and interchangeably receiving an accessory item. In the illustrated embodiments, the base comprises a strap or band having a length configured to surround a body part of a user, such as a wrist, an ankle, a waist, an arm, a leg, a neck, a head, or another body part of the user. Alternatively, the length can be used to surround a tangible object. In the illustrated embodiments of FIGS. 1B-1E, each base comprises a plurality of buttons that are configured to receive an elastic cord (not shown) that is configured to extend over at least two of the buttons for attachment. Thus, in one embodiment, the elastic cord is in a “FIG. 8” configuration to extend over and couple at least two opposing buttons. The combination of the buttons and elastic cord al lows for the base to be maintained on the user's body part. Use of an elastic cord or fastener permits a single base to accommodate several body parts having various circumferences. Additionally, use of an elastic cord or fastener provides an accessory system that can adapt to various circumferences of a desired body part.

In some embodiments, a non-elastic cord is used to couple the buttons, thus maintaining the base on the body part of the user. In some embodiments, the base comprises a stretchable material, such as an elastic webbing material. In other embodiments, the base comprises a rigid or inflexible material, such as leather, broad cloth, nylon webbing, lace, fabric, metal, or another material.

In some embodiments, base 12 further comprises a mounting surface 14 having fasteners 40 for compatibly, and interchangeably receiving various accessory items 20. Fasteners 40 generally include any fastener capable of facilitating attachment of accessory items 20 to base 12 of the modular accessory system 10. For example, in some embodiments fastener 40 comprises at least one of a hook-and-loop fastener, such as Velcro®, a snap button fastener, a latchet fastener, a clasp fastener, such as a Bocklebee clasp, a clip fastener, a buckle fastener, a zipper, a lace fastener, a magnetic fastener, and combinations thereof. A first half of fastener 40 is directly coupled to mounting surface 14 of base 12. A second half 42 of fastener 40 is directly coupled to accessory item 20. Thus, accessory item 20 is coupled to base 12 by simply joining first and second halves 40 and 42 of fastener 40.

In some embodiments, mounting surface 14 comprises a single fastener 40. In other embodiments, mounting surface 14 comprises two or more fasteners. Further, in some embodiments fastener 40 forms a single contact with accessory item 20. In other embodiments, fastens 40 forms multiple contacts with accessory item 20.

In some embodiments, accessory item 20 is combined with an adapter 50 to facilitate coupling of accessory item 20 to base 12. In some embodiments, adapter 50 comprises a first end 52 supporting fastener 40, and a second end 54 coupled to accessory item 20. Adapter 50 may be permanently or removably coupled to accessory item 20. Thus, adapter 50 facilitates attachment of accessory item 20 to base 12.

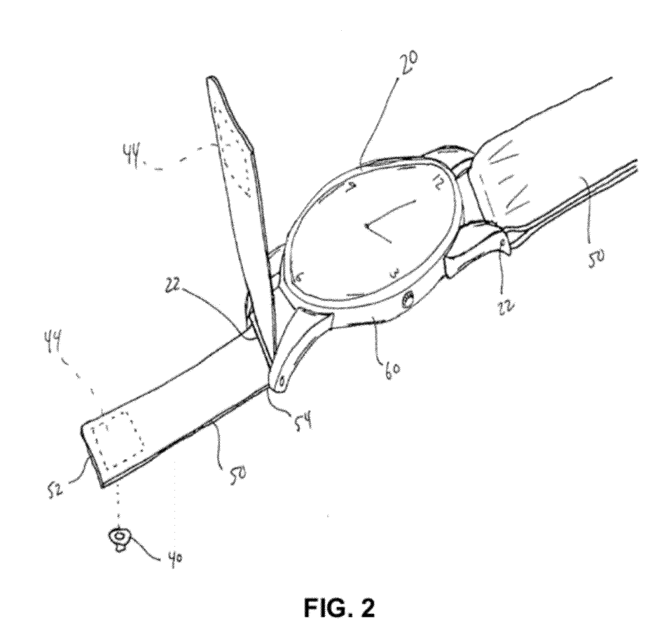

Referring now to FIG. 2, in some embodiments adapter 50 comprises a closeable loop that is threaded through a physical feature of accessory item 20, such as a spring bar 22 of a watch 60. In some embodiments, adapter 50 comprises a loop that is selectively closed via a reversible fastener 44, such as a hook-and-loop fastener. First end 52 further includes a fastener 40 whereby to attach adapter 50 to base 12 of accessory system 10.

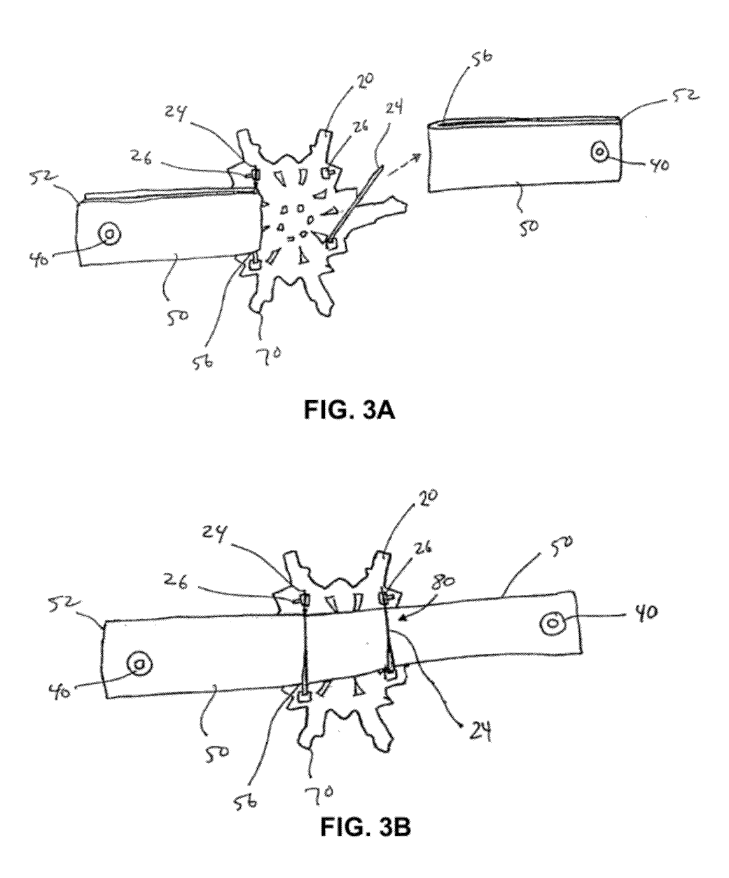

With reference to FIG. 3A, in some embodiments adapter 50 comprises a loop through which is inserted a physical feature of an accessory item 20, such as a pin 24 of a brooch 70. In some embodiments, pin 24 is removed from retaining clasp 26 and insertedly positioned through loop 56 of adapter 50. Pin 24 is then retained within retaining clasp 26 thereby securing brooch 70 to adapter 50. In other embodiments, adapter 50 comprises a loop that is selectively closed and opened thereby enabling the user to open adapter 50 and form a loop 56 around pin 24. Adapter 50 is then closed by means of fastener 44. First end 52 further includes a fastener 40 whereby to attach adapter 50 to base 12 of accessory system 10.

In some embodiments, adapter 50 is threaded through a channel or pathway 80 defined by a space between pins 24, retaining cl asps 26, and a back surface of brooch 70. In some embodiments, the thickness of adapter 50 provides sufficient friction between pathway 80 and adapter 50 such that the position of brooch 70 is maintained despite movement of the user. In other embodiments, brooch 70 is permitted to slide along adapter 50 in response to movement of the user.

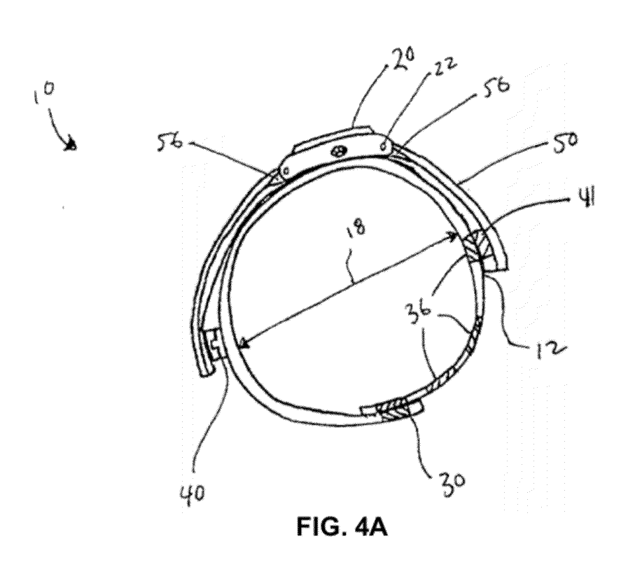

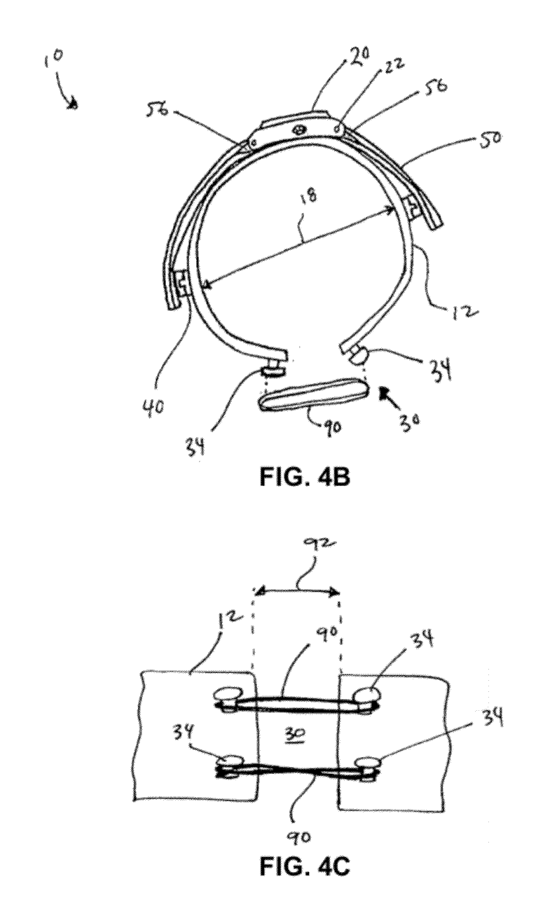

Following attachment of adapter 50 to base 12, base 12 is closed around an object or body part via fasteners 30, as shown in FIG. 4A. In some embodiments, fasteners 30 comprise a magnetic fastener, such as opposing rare-earth magnets. In other embodiments, fasteners 30 comprise a hook-and-loop interface. In some embodiments, base 12 comprises multiple fasteners 36 spaced so as to provide calculated placement of fastener 30. Thus, a combination of fastener 30 with one of the multiple fasteners 36 will provide various diameters 18 of modular accessory system 10.

In some embodiments, an additional fastener 36 is positioned opposite a magnetic fastener 41 embedded within, or attached to adapter 50. Thus, in some embodiments an accessory is magnetically attached to base 12 via adapter 50 and magnetic fasteners 36 and 41.

With reference to FIGS. 4B and 4C, in some embodiments fastener 30 comprises a plurality of oppositely positioned buttons 34, wherein base 12 is secured around an item or body part of a user by interconnecting buttons 34 with a retention strap or band 90. In some embodiments, band 90 comprises an elastomeric band. In other embodiments, band 90 comprises a static band.

When securing base 12 around an item or body part, a user may close gap 92 between terminal ends of base 12 by twisting band 90 between opposing buttons 34. In other embodiments, gap 92 is closed by wrapping multiple loops of band 90 around button 34, thus effectually shortening the length of band 90 which spans gap 92. Further, in some embodiments band 90 interconnects diagonally positioned buttons 34.

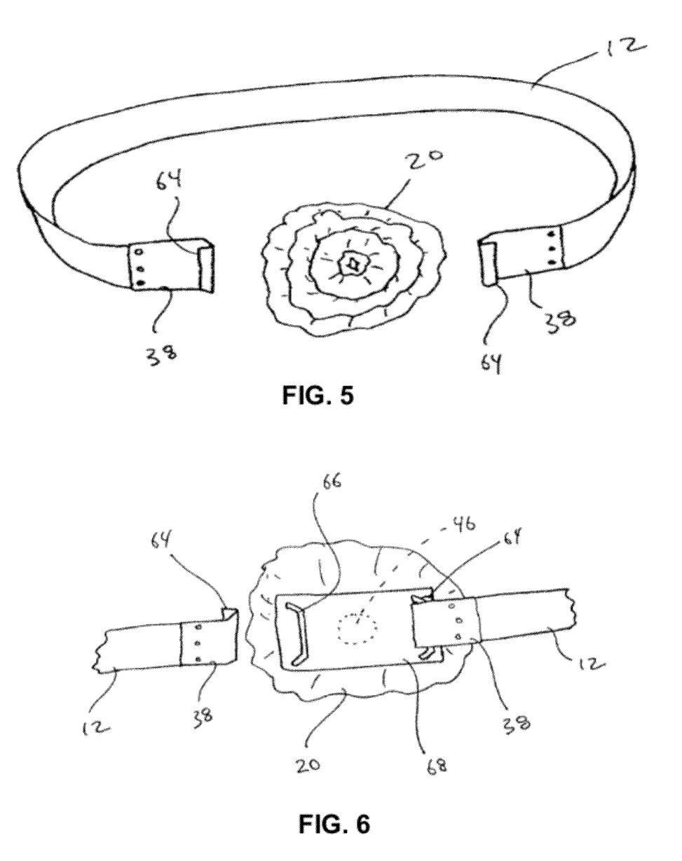

In some embodiments, base 12 comprises an extended band having terminal fasteners 38 for directly coupling to accessory item 20, as shown in FIGS. 5 and 6. Again, base 12 may comprise any length sufficient to surround a desired body part. For example, in some embodiments base 12 comprises a length sufficient to accommodate enclosure of a user's waist.

As previously discussed, base 12 may include elastic or inelastic material. In some embodiments, terminal fasteners 38 comprise a hook 64 whereby to engage a post or handle 66 directly coupled to accessory item 20. In some embodiments, handle 66 comprises a structural feature of accessory 20, such as a spring pin of a watch. In other embodiments, handle 66 is coupled to accessory 20 via a mounting plate 68. Mounting plate 68 may be a physical feature of accessory item 20, or may include a fastening feature 46 whereby by accessory item 20 is selectively and/or reversibly coupled to mounting plate 68. Thus, in some embodiments accessory item 20 is coupled to base 12 by simply coupling terminal fasteners 38 handle 66 of mounting plate 68.

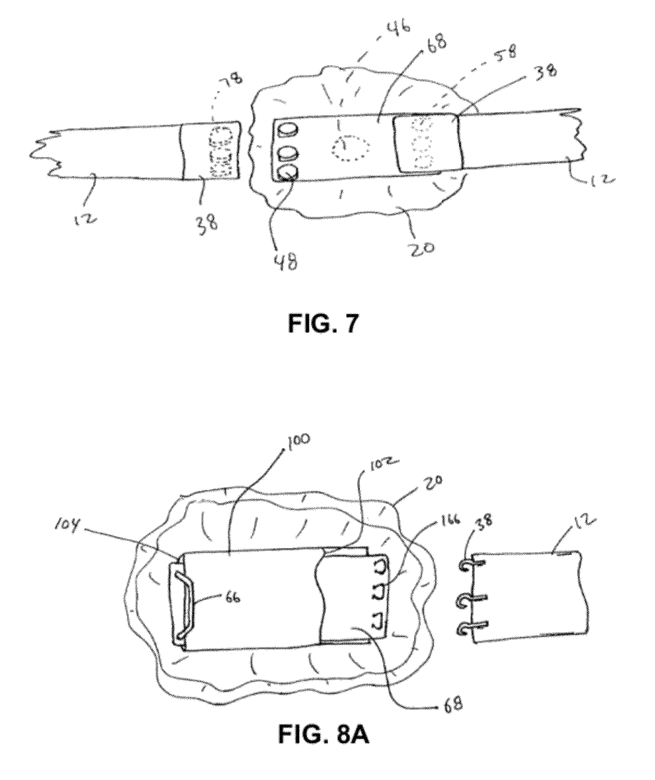

In some embodiments, terminal fasteners 38 comprise a metallic cap that magnetically couple to mounting plate 68 via magnetic fasteners 48, as shown in FIG. 7. In other embodiments, terminal fastener 38 comprises a magnetic fastener 58 that is magnetically coupled to metallic mounting plate 68. Further, in some embodiments terminal fastener 38 comprises magnetic fasteners 78 that magnetically couple to mounting plate 68 via magnetic fasteners 48. Thus, in some embodiments accessory item 20 is interchanged by simply removing mounting plate 68 from terminal fasteners 38, and replacing accessory item 20 with a second accessory item. In other embodiments, accessory item 20 is interchanged by simply removing accessory item 20 from mounting plate 68 (via fastener 46) and replacing accessory item 20 with a second accessory item.

Referring now to FIGS. 8A-8C, in some embodiments accessory item 20 is interchangeably coupled to mounting plate 68 via an accessory sleeve 100. In some embodiments, accessory sleeve 100 comprises a sleeve having a pathway 102 through which mounting plate 68 is inserted and housed. Thus, mounting plate 68 is inserted into pathway 102 by guiding handle 66 or loops 166 though pathway 102 such that handle 66 and loops 166 are positioned external to pathway 102. Handle 66 and loops 166 are thereby made available to be coupled to base 12 via a compatible terminal fastener 38.

Accessory sleeve 100 further comprises a mounting surface 104 for receiving and supporting an accessory item 20. In some embodiments, accessory item 20 is permanently coupled to mounting surface 104 via an adhesive, or another permanent method, such as by being sewn directly to mounting surface 104. In other embodiments, accessory item 20 is interchangeably coupled to mounting surface 40 via fastener 130, as shown in FIG. 8C. In some embodiments, fastener 130 comprises a button-and-loop fastener. In other embodiments, fastener 130 comprises at least one of a hook-and-loop fastener, such as Velcro®, a snap button fastener, a latchet fastener, a clasp fastener, such as a Bocklebee clasp, a clip fastener, a buckle fastener, a zipper, a lace fastener, a magnetic fastener, any other type of suitable fastener, and combinations thereof. Thus, accessory sleeve 100 may be interchangeably used with a variety of different accessory items 20.

The present invention relates to a modular personal accessory system. In particular, the present invention relates to system and methods for providing personal accessory items that are interchangeably used with a base having a compatible mounting surface.

The present invention may be embodied in other specific forms without departing from its spirit or essential characteristics. Therefore, the described embodiments are to be considered in all respects only as illustrative and not restrictive. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A modular personal accessory system, comprising:
a base member having a mounting surface for receiving an accessory item; and
a fastener interposed between the base member and the accessory item.
